(19) United States
(12) Patent Application Publication
(10) Pub. No.: US 2012/0063161 A1
(43) Pub. Date: Mar. 15, 2012

(54) LIGHT SOURCE DEVICE AND DISPLAY APPARATUS

(75) Inventors: Hiromi NAKANISHI, Itami-shi (JP); Michitomo IIYAMA, Itami-shi (JP)

(73) Assignee: SUMITOMO ELECTRIC INDUSTRIES, LTD., Osaka-shi (JP)

(21) Appl. No.: 13/231,714

(22) Filed: Sep. 13, 2011

(30) Foreign Application Priority Data
Sep. 15, 2010 (JP) 2010-207021

(51) Int. Cl. G09F 13/00; G02B 6/02; F21V 29/00

(52) U.S. Cl. 362/560; 362/580; 362/581

(57) ABSTRACT

A light source device includes a single optical waveguide, a plurality of optical sub-assemblies, and an assembly holder. The optical waveguide includes a core area extending along a predetermined axis, a cladding area covering a periphery of the core area, and a first end face extending along a plane intersecting the predetermined axis. The assembly holder has an inner surface supporting the optical sub-assemblies so that the optical sub-assemblies are respectively arranged on a plurality of reference lines and optically coupled to the first end face of the optical waveguide. Each optical sub-assembly includes a semiconductor light-emitting element having a light-emitting surface optically coupled to the first end face of the optical waveguide, and a support member on which the semiconductor light-emitting element is mounted. The reference lines extend in different directions from one point on a predetermined axis of the core area to the cladding area.

### BACKGROUND OF THE INVENTION

1. Field of the Invention

The present invention relates to a light source device and a display apparatus.

2. Related Background Art

Japanese Unexamined Patent Application Publication No. 2006-186066 discloses a small laser light source that can provide a portable laser display apparatus.

Japanese Unexamined Patent Application Publication No. 2004-273620 discloses a laser apparatus. The laser apparatus has a combination of a plurality of laser diodes and a collimator lens array. The laser apparatus does not generate mismatch between the pitch of the light-emitting points of the laser diodes and the pitch of the collimator lens array.

Japanese Unexamined Patent Application Publication No. 2007-041342 discloses a multiplexing light source. The multiplexing light source multiplexes light beams from a plurality of light sources and generates multiplexed light. The multiplexed light has high output power and high luminance.

### SUMMARY OF THE INVENTION

In Japanese Unexamined Patent Application Publication No. 2006-186066, the laser light source emitting RGB laser light beams includes a blue laser diode (first laser diode) emitting blue laser light, a red laser diode (second laser diode) emitting red laser light, and a green laser diode (third laser diode) emitting green laser light. The third laser diode includes a DBR laser diode and a wavelength conversion element that convert the wavelength of a laser light from the DBR laser diode. These first to third laser diodes are mounted in a single package while being in contact with one heat sink. Since the heat sink is provided so as to cover the periphery of the wavelength conversion element, various characteristics of the wavelength conversion element do not fluctuate by heat from the blue and red laser diodes even if the wavelength conversion element and the blue and red laser diodes are mounted in a single package. Unfortunately, in the laser light source disclosed in Japanese Unexamined Patent Application Publication No. 2006-186066, thermal interference between the laser diodes is noticeable because the heat dissipates from the three laser diodes housed in the single package through the single heat sink. This thermal interference precludes a further reduction in size of the laser light source. The thermal interference increases the temperature of the laser light source. Thus, a desired intensity of light results in further generation of heat. In addition, electrical characteristics cannot be inspected before the three laser diodes are assembled into the single package. Accordingly, the rate of nondefective light source devices depends on the product of the rate of the individual nondefective laser diodes.

In Japanese Unexamined Patent Application Publication No. 2004-273620, the laser apparatus includes a plurality of laser diodes of which light-emitting points are aligned, a collimator lens array that respectively collimates laser beams from the light-emitting points, a collection lens that collects the collimated laser beams, and an optical fiber that multiplexes the collected laser beams. In this laser apparatus, the laser diode and/or the collimator lens array is heated by a heater and the light intensity of the laser beams from the optical fiber is detected by a means for detecting the light intensity. The drive of the heater is controlled to maximize the light intensity. Accordingly, in Japanese Unexamined Patent Application Publication No. 2004-273620, optical alignment is required between the plurality of laser diodes and the lens array. Furthermore, it is cumbersome to use separate lens components.

In the multiplexing light source disclosed in Japanese Unexamined Patent Application Publication No. 2007-041342, light beams emitted from a plurality of light sources transmits multi-mode optical fibers and are multiplexed by several first fiber multiplexers. These first fiber multiplexers generate first multiplexed beams. The first multiplexed beams are further multiplexed by second fiber multiplexers. The fiber multiplexers generate second multiplexed beams. In Japanese Unexamined Patent Application Publication No. 2007-041342, the optical fibers are optically connected by fusion bonding. This requires alignment of positions of the cores of the optical fibers to be bonded by fusion with an accuracy of sub-micron order in order to reduce the loss of the optical connection by fusion bonding. Accordingly, the loss in the optical transmission path must be reduced.

In view of reduction in size of the light source device, it is required to reduce a thermal interference caused by heat-dissipating structure disclosed in Japanese Unexamined Patent Application Publication No. 2006-186066, and to avoid the optical coupling in Japanese Unexamined Patent Application Publication No. 2004-273620 (namely, optical coupling with lens components).

A light source device according to an aspect of the present invention includes; (a) a single optical waveguide that includes a core area extending along a predetermined axis, a cladding area covering a periphery of the core area and extending along a predetermined axis, and the first end face extending along a plane intersecting a predetermined axis; (b) a plurality of optical sub-assemblies; and (c) an assembly holder having an inner surface that supports the plurality of optical sub-assemblies such that the plurality of optical sub-assemblies are respectively arranged on a plurality of reference lines and optically coupled to the first end face of the optical waveguide. Each of the optical sub-assemblies includes a semiconductor light-emitting element having a light-emitting surface that is optically coupled to the first end face of the optical waveguide, and a support member on which the semiconductor light-emitting element is mounted. The support member includes a first electrode and a second electrode that are electrically connected to a first electrode and a second electrode of the semiconductor light-emitting element, respectively. The support members of the optical sub-assemblies are spaced apart from each other in the assembly holder, and the assembly holder directs the light-emitting surface of the semiconductor light-emitting element toward the first end face of the optical waveguide. The plurality of reference lines extend in different directions from one point on a predetermined axis of the core area to the cladding area.

In a light source device according to an aspect of the present invention, the assembly holder may have a hole extending from a first end to a second end of the assembly holder in the direction of the predetermined axis, and the plurality of support members may be arranged in the hole of the assembly holder.

In a light source device according to an aspect of the present invention, the support member may include a heat sink on which the semiconductor light-emitting element is die-bonded and a mount member having a main surface on which the heat sink is mounted and a back surface supported by the assembly holder. Each of the optical sub-assemblies may further include a lead terminal supported by the mount member.

In the light source device according to an aspect of the present invention, the inner surface of the assembly holder may include a plurality of supporting surfaces that respectively supports a plurality of optical sub-assemblies, and a plurality of separating grooves formed between the plurality of supporting surfaces.

In the light source device according to an aspect of the present invention, the semiconductor light-emitting element may include a substrate and a multilayer semiconductor structure provided on the substrate, and the support member may support the substrate.

In the light source device according to an aspect of the present invention, the core may have a substantially circular cross-section, and a light-emitting area in a light-emitting surface of the semiconductor light-emitting element may be arranged along a circle around a point on a predetermined axis.

In the light source device according to an aspect of the present invention, the diameter of the circle may be smaller than the diameter of the cross-section of the core area.

The light source device according to an aspect of the present invention may further include a waveguide holder for supporting the optical waveguide. The assembly holder may have an alignment surface, and the alignment surface may support an end of the waveguide holder and extend along a reference plane intersecting a predetermined axis.

The light source device according to an aspect of the present invention may further include a waveguide holder for supporting the optical waveguide. Each of the assembly holder and the waveguide holder may have a positioning structure for optical alignment between the assembly holder and the waveguide holder.

In a light source device according to an aspect of the present invention, the optical waveguide may include a large-diameter optical fiber.

In the light source device according to an aspect of the present invention, the optical waveguide may include any one of an optical fiber having a core comprising plastic, an optical fiber having a core comprising quartz glass, an optical fiber having a core comprising polyimide material, a planar waveguide having a core comprising plastic, a planar waveguide having a core comprising quartz glass, a planar waveguide having a core comprising polyimide material, and a photonic crystal.

Another aspect of the present invention is a display apparatus including the above-described light source device. The display apparatus according to another aspect of the present invention includes (a) any one of the above-described light source device; (b) a mirror device receiving light from the second end face of the optical waveguide of the light source device; (c) a lens generating projection light from a reflected light from the mirror device; and (d) a control unit driving the semiconductor light-emitting element of the light source device and controlling the mirror device. Furthermore, the display apparatus according to another aspect of the present invention includes (a) any one of the above-described light source device; (b) a lens collimating light from the second end face of the optical waveguide; (c) an MEMS including a mirror receiving the light from the lens; and (d) a control unit driving the semiconductor light-emitting element of the light source device and scanning light reflected from the MEMS by controlling the MEMS.

The above-described objects and other objects, features, and advantages of the present invention will become apparent from the detailed description described below on the preferred embodiments of the present invention with reference to the accompanying drawings.

### BRIEF DESCRIPTION OF THE DRAWINGS

FIG. 1 is a schematic illustration of a light source device according to an embodiment;

FIG. 2 is a schematic illustration of an optical sub-assembly;

FIG. 3 illustrates an arrangement of the optical sub-assembly supported by an assembly holder in the light source device according to the embodiment;

FIG. 4 illustrates an embodiment of the optical sub-assemblies aligned in the sub-assembly holder;

FIG. 5 is a table showing an exemplary coordinate system in an arrangement of a first optical sub-assembly and a second optical sub-assembly;

FIG. 6 illustrates an arrangement of an optical waveguide and a waveguide sub-assembly;

FIG. 7 illustrates an embodiment of the light source device;

FIG. 8 illustrates other embodiment of the light source device;

FIG. 9 is a flowchart showing main steps in a method for manufacturing the light source device;

FIG. 10 illustrates an exemplary display apparatus according to an embodiment; and

FIG. 11 illustrates another exemplary display apparatus according to the embodiment.

### DESCRIPTION OF THE PREFERRED EMBODIMENTS

The knowledge of the present invention will be easily understood from the following detailed description with reference to attached drawings. Embodiments of a light source device, an illumination unit, and a display apparatus according to the present invention will be described with reference to the attached drawings. The same reference numerals are assigned to the same components wherever possible.

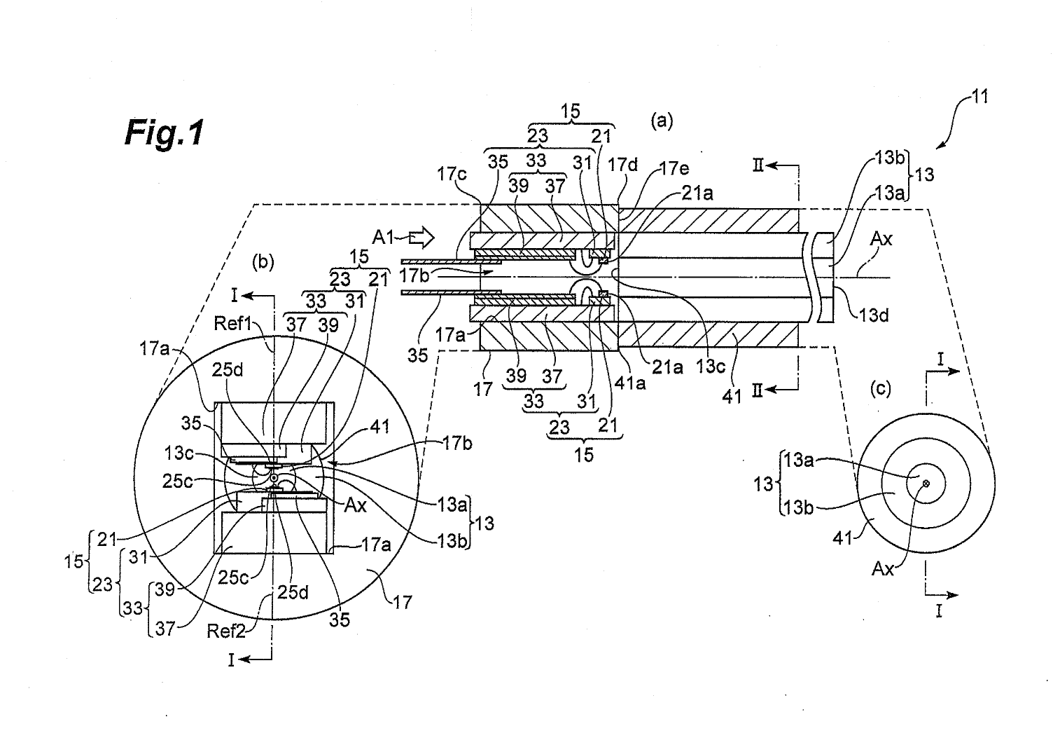

FIG. 1 is a schematic illustration of a light source device according to the present embodiment. Part (a) of FIG. 1 is a cross-sectional view taken along line I-I in Parts (b) and (c) of FIG. 1. Part (b) of FIG. 1 illustrates an end surface of the light source device viewed from the direction of arrow Al in Part (c) of FIG. 1. Part (c) of FIG. 1 is a cross-sectional view taken along line II-II in Part (a) of FIG. 1.

The light source device 11 includes a single optical waveguide 13, multiple optical sub-assemblies 15, and an assembly holder 17. The optical waveguide 13 includes a core area 13a and a cladding area 13b. The refraction index of the core area 13a is greater than that of the cladding area 13b. The core area 13a extends along a predetermined axis Ax. The cladding area 13b covers the periphery of the core area 13a. The cladding area 13b also extends along the predetermined axis Ax. The predetermined axis Ax may be positioned in the center of the core area 13a, for example. The optical waveguide 13 includes a first end face 13c and a second end face 13d. The first end face 13c extends along a plane intersecting the predetermined axis Ax. The assembly holder 17 includes an inner surface 17a. The inner surface 17a supports the optical sub-assemblies 15. The assembly holder 17 supports these optical sub-assemblies 15 such that the optical sub-assemblies 15 are optically coupled to the first end face 13c of the waveguide 13. As a result of such a supporting structure, the assembly holder 17 directs a light-emitting surface 21a of a semiconductor light-emitting element 21 toward the first end face 13c of the optical waveguide 13. Each of the optical sub-assemblies 15 includes the semiconductor light-emitting element 21 and a support member 23. The support member 23 is aligned relative to the optical waveguide 13 on the inner surface 17a of the assembly holder 17. The inner surface 17a of the assembly holder 17 supports the optical sub-assemblies 15 such that the optical sub-assemblies 15 are optically coupled to the first end face 13c of the optical waveguide 13, and arranged on the respective reference lines (for example, Ref 1 and Ref 2). With reference to Part (b) of FIG. 1, the reference lines Ref 1 and Ref 2 extend in different directions from a point on the predetermined axis Ax. The reference lines Ref 1 and Ref 2 extend from the core area 13a to the cladding area 13b.

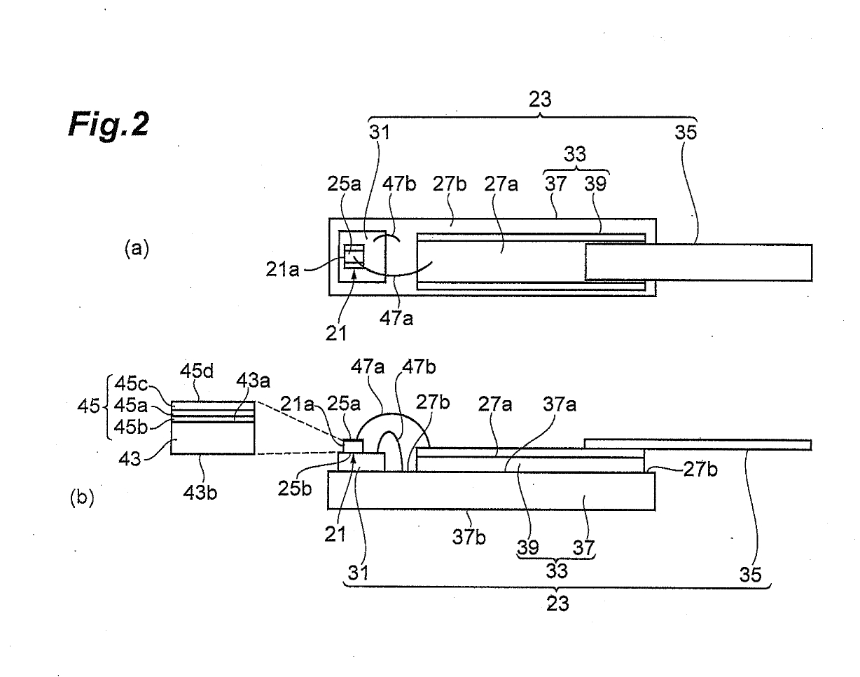

FIG. 2 is a schematic illustration of an optical sub-assembly. Referring to Parts (a) to (c) of FIG. 1 and Parts (a) and (b) of FIG. 2, each of the semiconductor light-emitting elements 21 of the optical sub-assemblies 15 includes a light-emitting surface 21a optically coupled to the first end face 13c of the optical waveguide 13, and includes a first electrode 25a and a second electrode 25b. The semiconductor light-emitting element 21 may be of an end surface light-emitting type, for example. The semiconductor light-emitting element 21 is mounted on the support member 23. The support member 23 includes a first electrode 27a and a second electrode 27b electrically connected to a first electrode 25a and a second electrode 25b of the semiconductor light-emitting element 21, respectively. The support members 23 of the optical sub-assemblies 15 are spaced apart from each other in the assembly holder 17.

According to the light source device 11, each of the optical sub-assemblies 15 includes the semiconductor light-emitting element 21 and the support member 23. The support member 23 includes the first electrode 27a and the second electrode 27b electrically connected to the first electrode 25a and the second electrode 25b of the semiconductor light-emitting element 21, respectively. Accordingly, every optical sub-assembly 15 can be independently inspected for electrical characteristics. Moreover, the assembly holder 17 directs the semiconductor light-emitting element 21 toward the first end face 13c of the optical waveguide 13; hence, the light-emitting surface 21a of the semiconductor light-emitting element 21 is directed to the core surface of the first end face 13c of the optical waveguide 13. Consequently, the semiconductor light-emitting elements 21 can be optically coupled to the optical waveguide 13 without separate lens components. Furthermore, the assembly holder 17 supports the optical sub-assemblies 15, which are arranged on a plurality of reference lines (for example, Ref 1 and Ref 2) and are optically coupled to the first end face 13c of the optical waveguide 13. The independent reference lines (for example, Ref 1 and Ref 2) extend in different directions from a point on the predetermined axis Ax, and the lines extend from the core area 13a to the cladding area 13b. For example, the semiconductor light-emitting elements 21 can be aligned along a border line between the core area 13a and the cladding area 13b defined on the first end face 13c of the optical waveguide 13. Accordingly, the semiconductor light-emitting elements 21 can be arranged close to each other, while providing the optical coupling. Since the semiconductor light-emitting elements 21 are mounted on the optical sub-assemblies 15 supported by the assembly holder 17, thermal interference between the semiconductor light-emitting elements 21 can be avoided.

In the present embodiment, the semiconductor light-emitting elements 21 are directly coupled with the first end face 13c of the single optical waveguide 13 without additional lenses.

The optical waveguide 13 may include a large-diameter optical fiber. According to the light source device 11, such a large-diameter optical fiber can provide sufficient optical coupling. The diameter of the large-diameter optical fiber may range, for example, from about 200 μm to about 1000 μm, and specifically, may be about 500 μm, for example. The aperture ratio of the large-diameter optical fiber may range from about 0.1 to about 0.5. For example, the light source device 11 for use in a display propagates light having a wavelength of, for example, about 460 nm to about 650 nm (for example, visible light) through the optical waveguide 13. In the light source device 11 for use in a sensor monitoring a display function or a human sensor, the light having a wavelength of about 800 nm to about 5000 nm (for example, infrared light) is propagated. The length of the optical waveguide 13 may be in the range of, for example, about 3 mm to about 20 mm, and any other length may be employed if necessary.

The optical waveguide 13 may include any one of an optical fiber having a plastic, quartz glass, or polyimide core, a planar waveguide having a plastic, quartz glass, or polyimide core, and a photonic crystal. As the photonic crystal, silicone is used, for example. According to the light source device 11, the above-described optical waveguide is preferably applied.

With reference to FIG. 1, the assembly holder 17 has a hole 17b. The hole 17b extends in the direction of the predetermined axis Ax from a first end 17c to a second end 17d of the assembly holder 17. The support member 23 may be arranged in the hole 17b of the assembly holder 17. According to the light source device 11, since the support member 23 can be arranged in the hole 17b of the assembly holder 17, the optical coupling can be performed by aligning the hole 17b to the optical waveguide 13. Accordingly, the semiconductor light-emitting element 21 on the support member 23 can be optically coupled to the first end face 13c of the optical waveguide 13 with ease.

As illustrated in FIG. 1 and FIG. 2, the support member 23 includes a heat sink 31 and a mount member 33. The semiconductor light-emitting element 21 is die-bonded on the heat sink 31. A back surface of the mount member 33 is supported by the inner surface 17a of the assembly holder 17. Each of the optical sub-assemblies 15 further includes a lead terminal 35. Since the support member 23 include the heat sink 31, and since the optical sub-assembly 15 includes the lead terminal 35, the support member 23 and the lead terminal 35 facilitate heat dissipation from the semiconductor light-emitting element 21 and the electrical connection of the semiconductor light-emitting element 21.

The heat sink 31 is mounted on the mount member 33. The heat sink 31 is made of ceramics such as aluminum nitride, Si, or SiC for example. A conductive film made of, for example, AuSn or SnAg may be formed on a main surface of the heat sink 31 by, for example, vapor deposition. The lead terminal 35 is supported by the mount member 33. In this embodiment, the mount member 33 includes a support member 37 and a wiring member 39. The support member 37 includes a main surface 37a and a back surface 37b. The back surface 37b of the support member 37 is fixed to the inner surface 17a of the assembly holder 17. The main surface 37a of the support member 37 supports the wiring member 39, and the wiring member 39 supports the S lead terminal 35. A pair of lines for supplying electric power to the semiconductor light-emitting element 21 are formed on the support member 37 and the wiring member 39, the pair of lines extend to a first end of the assembly holder 17. The wiring member 39 includes a conductive pattern connected to the lead terminal 35 and extending in the direction of the predetermined axis Ax. On the main surface 37a of the support member 37, another conductive pattern insulated from the conductive pattern of the wiring member 39 is provided, and extends in the direction of the predetermined axis Ax. The support member 37 may be made of a material having relatively high thermal conductivity, such as Fe or CuW. The heat from the semiconductor light-emitting element 21 reaches the assembly holder 17 through the heat sink 31 and the support member 37.

As illustrated in FIG. 1, the light source device 11 may further include a waveguide holder 41 holding the optical waveguide 13. The assembly holder 17 includes an alignment surface 17e extending along the reference plane intersecting the predetermined axis Ax. The alignment surface 17e supports an end 41a of the waveguide holder 41. According to this light source device 11, the end 41 a of the waveguide holder 41 slides on the alignment surface 17e of the assembly holder 17, so that the optical sub-assemblies 15 supported by the inner surface 17a of the assembly holder 17 can be optically aligned to the optical waveguide 13 supported by the waveguide holder 41. The optical sub-assemblies 15 may be fixed with solder, Ag paste, or resin having high heat-dissipation characteristics, for example.

As illustrated in FIG. 2, the semiconductor light-emitting element 21 includes a substrate 43 and a multilayer semiconductor structure 45 provided on a main surface 43a of the substrate 43. The multilayer semiconductor structure 45 includes, for example, an active layer 45a, an n-type semiconductor area 45b including an n-type cladding layer, and a p-type semiconductor area 45c including a p-type cladding layer. The active layer 45a is provided between the n-type semiconductor area 45b and the p-type semiconductor area 45c. The second electrode 25b is in contact with a back surface 43b of the substrate 43. In addition, the first electrode 25a is in contact with an upper surface 45d of the multilayer semiconductor structure 45.

The first electrode 25a is connected to the first electrode 27a via a conductive wire, such as a bonding wire 47a. The second electrode 25b is connected to the second electrode 27b via a conductive wire, such as a bonding wire 47b.

The support member 23 can support the substrate 43 of the semiconductor light-emitting element 21. According to this light source device 11, since the support member 23 supports the substrate 43 of the semiconductor light-emitting element 21, the substrate 43 of the semiconductor light-emitting element 21 and the multilayer semiconductor structure 45 are arranged in sequence in a direction from the cladding area 13b to the core area 13a of the optical waveguide 13. Accordingly, the multilayer semiconductor structure 45 including an active layer 45a is disposed closer to the axis As (for example, a center line of the core area 13a) than the substrate 43 is. Accordingly, a light-emitting surface of the active layer 45a can be located close to the center of the core area 13a.

In the light source device 11, for example, the waveguide holder 41 and the assembly holder 17 may each include a positioning structure for performing the optical alignment between the waveguide holder 41 and the assembly holder 17. Examples of such positioning structures are lugs and grooves formed on the waveguide holder 41 and the assembly holder 17, respectively. The positioning structures on the respective waveguide holder 41 and the assembly holder 17 facilitate optical alignment between a plurality of optical sub-assemblies 15 supported by the inner surface 17a of the assembly holder 17 and the optical waveguide 13 supported by the waveguide holder 41. The waveguide holder 41 may be made of metal or resin, for example. Furthermore, the assembly holder 17 may be made of a high thermally conductive material, such as metal or ceramics.

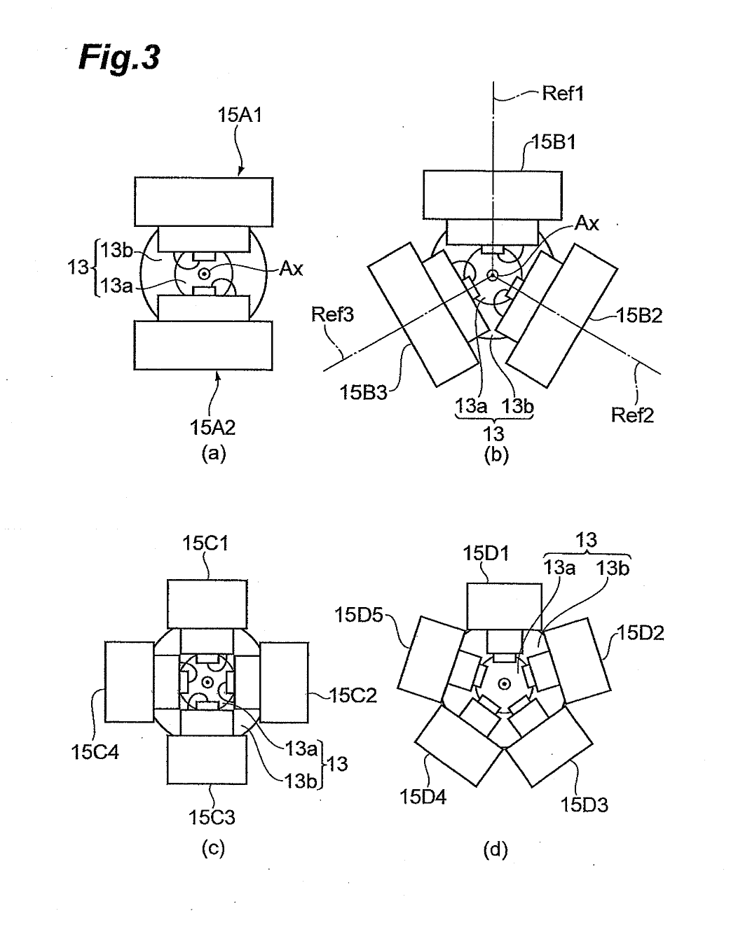

FIG. 3 illustrates an arrangement of the optical sub-assembly supported by an assembly holder in the light source device according to the embodiment. In FIG. 3, the assembly holder 17 is not illustrated so as to demonstrate the arrangement of the plurality of optical sub-assemblies 15. With reference to Part (a) of FIG. 3, an arrangement of two optical sub-assemblies 15A1 and 15A2 in the light source device 11 in Part (a) of FIG. 1 is illustrated. The position of one of the optical sub-assemblies 15A1 and 15A2 is defined by rotating the optical sub-assembly by an angle of 180 degrees around a point on the axis Ax with reference to the position of the other of the optical sub-assemblies 15A1 and 15A2. As illustrated in Part (b) of FIG. 1, the alignment of the optical sub-assemblies 15A1 and 15A2 is provided by two inner surfaces 17a of the assembly holder 17. These two inner surfaces 17a are in parallel with each other. The alignment of the optical sub-assemblies 15A1 and 15A2 is achieved by the direction of two inner surfaces 17a of the assembly holder 17 and two inner surfaces 17a respectively extend along two side faces of a hypothetical quadratic prism.

Part (b) of FIG. 3 illustrates an arrangement of three optical sub-assemblies 15B1, 15B2, and 15B3. The positions of the optical sub-assemblies 15B2 and 15B3 are defined by rotating these optical sub-assemblies by an angle of 120 and 240 degrees around a point on the axis Ax with reference to a position of the optical sub-assembly 15B1, for example. The arrangement of the optical sub-assemblies 15B1, 15B2, and 15B3 is achieved by three inner surfaces of the assembly holder 17. The three inner surfaces extend along the three side faces of a hypothetical triangle prism, respectively. In Part (b) of FIG. 3, three reference lines (for example, Ref 1, Ref 2, and Ref 3) are illustrated, and the optical sub-assemblies 15B1, 15B2, and 15B3 are arranged on these reference lines. The optical sub-assemblies 15B1, 15B2, and 15B3 are optically coupled to the first end face 13c of the optical waveguide 13. The reference lines Ref 1, Ref 2, and Ref 3 extend from the core area 13a to the cladding area 13b, and the reference lines Ref 1, Ref 2, and Ref 3 extend in different directions from one point on the predetermined axis Ax. In the present embodiment, the reference lines Ref 1, Ref 2, and Ref 3 mutually define an angle of 120 degrees.

With reference to Part (c) of FIG. 3, an arrangement of four optical sub-assemblies 15C1, 15C2, 15C3, and 15C4 is illustrated. Positions of the optical sub-assemblies 15C1 to 15C4 are defined by rotating the optical sub-assemblies 15C2 to 15C4 by angles of 90, 180, and 270 degrees, respectively, around a point on the axis Ax with reference to the position of the optical sub-assembly 15C1, for example. The arrangement of the optical sub-assemblies 15C1 to 15C4 is provided by four inner surfaces of the assembly holder 17. The four inner surfaces extend along four side faces of a hypothetical square prism, respectively.

With reference to Part (d) of FIG. 3, an arrangement of five optical sub-assemblies 15D1, 15D2, 15D3, 15D4, and 15D5 is illustrated. Positions of optical sub-assemblies 15D2 to 15D5 are defined by rotating the optical sub-assemblies 15D2 to 15D5 by angles of 72, 144, 216, and 288 degrees, respectively, around a point on the axis Ax with reference to the position of the optical sub-assembly 15D1, for example. The arrangement of the optical sub-assemblies 15D1 to 15D5 are provided by five inner surfaces of the assembly holder 17. The five inner surfaces extend along five side faces of a hypothetical pentagonal prism, respectively.

As described above, the arrangements of n number of optical sub-assemblies 15N1 . . . 15Nn (n indicates natural number) are illustrated corresponding to the size of the optical sub-assemblies. The positions of the optical sub-assemblies 15N2 to 15Nn are defined by rotating these optical sub-assemblies by angles of 360/n degrees around a point on the axis Ax with reference to the position of the optical sub-assembly 15N1, for example. The arrangements of the optical sub-assemblies 15N1 to 15Nn are provided by n number of inner surfaces of the assembly holder 17, and the inner surfaces extend along n number of side faces of a hypothetical n-gonal prism, respectively. By these arrangements, the thermal interference between the semiconductor light-emitting elements 21 can be avoided.

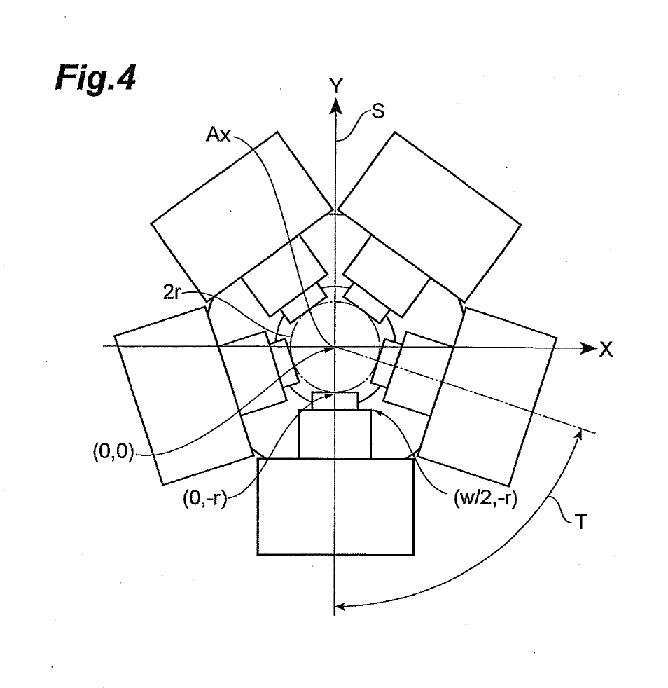

With reference to FIG. 4, a guideline of an alignment of the optical sub-assemblies 15 is described. In FIG. 4, an orthogonal coordinate system S is illustrated. The origin of the orthogonal coordinate system S is defined in the center of the core area 13a, and preferably, positioned on the axis Ax. In the first optical sub-assembly, the width of the semiconductor light-emitting element 21 is defined as w, coordinates of a light-emitting point in the light-emitting surface 21a of the semiconductor light-emitting element 21 is defined as (0, -r), the coordinates of the left end of an upper edge in the light-emitting surface 21 a of the semiconductor light-emitting element 21 is defined as (w/2, Δr-r), and the coordinates of the right end thereof is defined as (-w/2, Δr-r). The coordinates of the light-emitting point of a second optical sub-assembly (XL, YL) are introduced by first rotation 360/n degrees (=T) in a counterclockwise direction, where “Δr” indicates a difference between the y-ordinate in the light-emitting center and the y-ordinate on an upper surface of the element.

XL=r×sin (T)

YL=-r×cos (T)

Coordinates of the left end of the second optical sub-assembly (XE1, YE1) are introduced.

XE1=(r−Δr)×sin(T)−w/2×sin(90−T)

YE1=(r−Δr)×cos(T)−w/2×cos(90−T)

Coordinates of the right end of the second optical sub-assembly (XE2, YE2) are introduced.

XE2=(r−Δr)×sin(T)+w/2×sin(90−T)

YE2=(r−Δr)×cos(T)+w/2×cos(90−T)

When the positions of the optical sub-assemblies are determined in sequence by such rotations, the coordinates of the light-emitting point are aligned on a circle having a radius “r” around a point on an axis extending along the core area. Since the value of the “Δr” is, for example, several micrometers (for example, Δr=3 μm), it can be omitted in a simple calculation.,

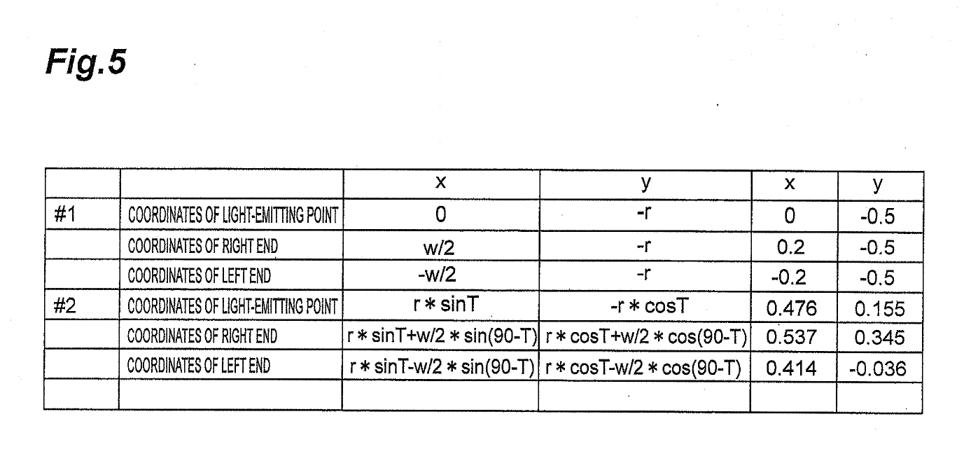

Since the semiconductor light-emitting element of the first optical sub-assembly cannot be overlapped with the semiconductor light-emitting element of the second optical sub-assembly, there is a limitation in the coordinates of the right end of the first optical sub-assembly and the coordinates of the left end of the second optical sub-assembly. FIG. 5 is a table illustrating an exemplary coordinates in an arrangement of the first optical sub-assembly and the second optical sub-assembly. At a rotation angle T of 72 degrees, a width w of the semiconductor light-emitting element 21 of 0.4 mm, and a radius r relating to coordinates of the light-emitting point of −0.5 mm, the coordinates of the right end of the first optical sub-assembly are found to be (0.2, −0.5) and the coordinates of the left end of the second optical sub-assembly are found to be (0.414, −0.036). Thus, the semiconductor light-emitting element of the first optical sub-assembly is not overlapped with the semiconductor light-emitting element of the second optical sub-assembly. In order to avoid complication, the difference Δr is set to (Δr=0 μm) in the above-described calculation and FIG. 5.

In the above-described arrangement, the light-emitting areas in the light-emitting surfaces 21a of the semiconductor light-emitting elements 21 are aligned along the circle around the point on the predetermined axis Ax. Such an arrangement is preferable when the core area has a substantially circular cross-section. The light-emitting surface 21a of the individual semiconductor light-emitting element 21 can be optically coupled to a first end face of the core area 13a efficiently. Furthermore, when the diameter 2r of the circle is smaller than the diameter of the cross-section of the core, the optical coupling efficiency between the light-emitting surface 21a of the individual semiconductor light-emitting element 21 and the first end face of the core area 13a can be enhanced.

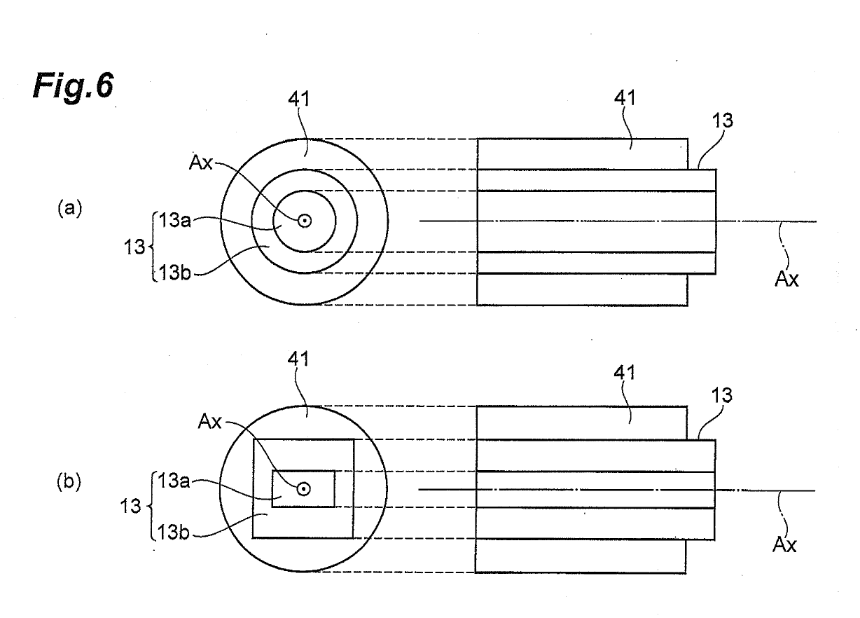

As described above, in the optical waveguide 13 for the light source device 11, as illustrated in FIG. 1 and Part (a) of FIG. 6, the core area 13a of the optical waveguide 13 may have a substantially circular cross-section, and the outer periphery of the optical waveguide 13 may have a substantially round shape. The optical waveguide 13 may be an optical fiber, for example. Alternatively, the optical waveguide 13 for the light source device 11 may have a core area 13a having an n-gonal shape in the cross-section of the optical waveguide 13, and may have a rectangular shape, as illustrated in Part (b) of FIG. 6.

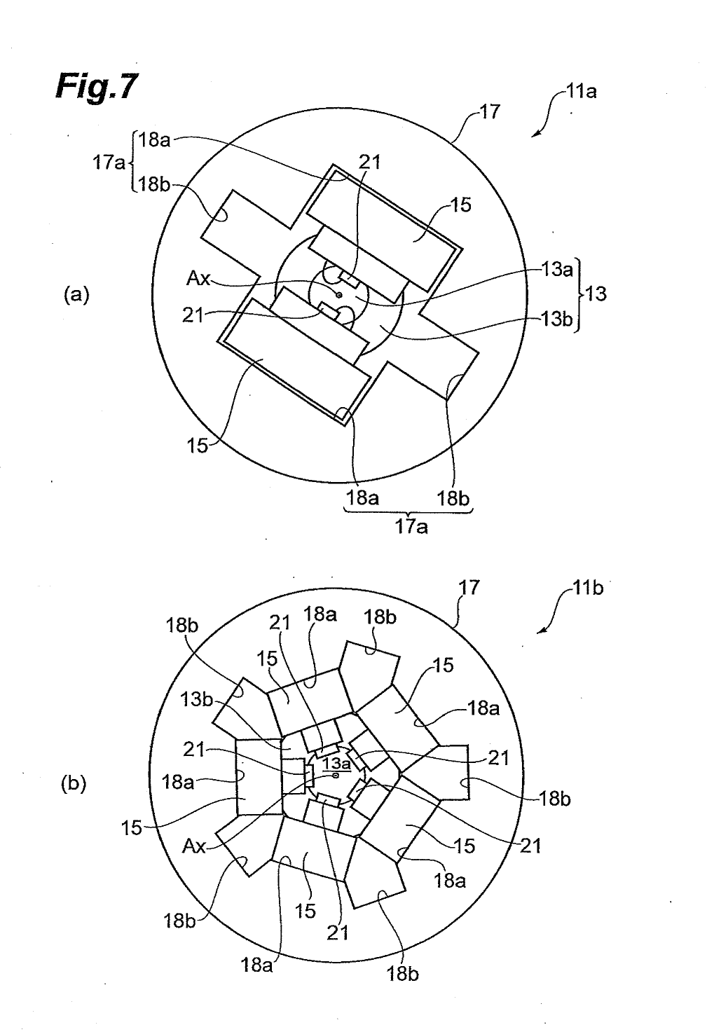

FIG. 7 is an illustration of an embodiment of a light source device. With reference to Parts (a) and (b) of FIG. 7, in light source devices 11a and 11b, the inner surface 17a of the assembly holder 17 includes a plurality of support surfaces 18a and a plurality of separation grooves 18b. The support surfaces 18a and the separation grooves 18b extend in the direction of the axis Ax. A plurality of the support surfaces 18a respectively support a plurality of optical sub-assemblies 15. The separation grooves 18b are formed between the support surfaces 18a. In these embodiments, the assembly holder 17 also directs the light-emitting surface 21a of the semiconductor light-emitting element 21 toward the first end face of the optical waveguide 13. According to the light source devices 11a and 11b, the heat can dissipate from the semiconductor light-emitting element 21 via the support surface 18a with ease. The thermal interference between the optical sub-assemblies 15 on the individual support surfaces 18a can be further reduced by the separation grooves 18b.

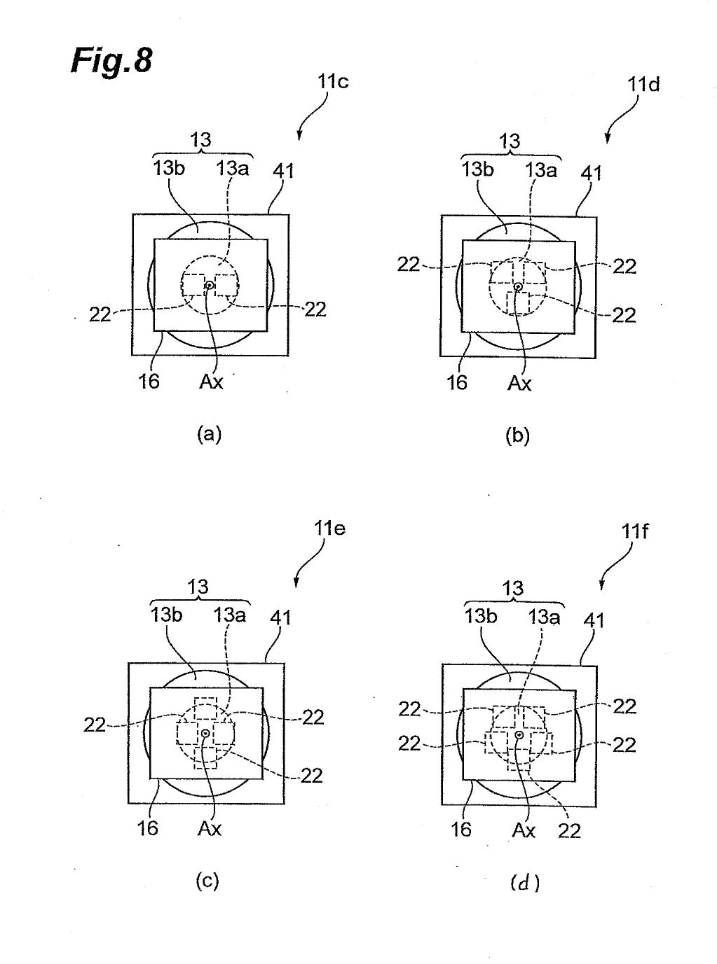

FIG. 8 is an illustration of another embodiment of the light source device viewed from a direction indicated by an arrow A1 in FIG. 1. Semiconductor light-emitting elements 22 may be surface-light-emitting elements. Each of the semiconductor light-emitting elements 22 is supported by a support surface of an assembly holder 16. In FIG. 8, a back surface on opposite side of the support surface is illustrated; hence, the semiconductor light-emitting elements 22 are illustrated by broken lines so as to indicate a position of the semiconductor light-emitting elements 22. The semiconductor light-emitting elements 22 on the support surface of the assembly holder 16 are optically coupled to the optical waveguide 13. In a light source device 11c in Part (a) of FIG. 8, two semiconductor light-emitting elements 22 are mounted on the assembly holder 16. Each of the semiconductor light-emitting elements 22 is arranged at a position that is two-fold rotational symmetry on the assembly holder 16. In a light source device lid in Part (b) of FIG. 8, three semiconductor light-emitting elements 22 are mounted on the assembly holder 16. Each of the semiconductor light-emitting elements 22 is arranged at a position that is three-fold rotational symmetry on the assembly holder 16. In a light source device lie in Part (c) of FIG. 8, four semiconductor light-emitting elements 22 are mounted on the assembly holder 16. Each of the semiconductor light-emitting elements 22 is arranged at a position that is four-fold rotational symmetry on the assembly holder 16. In a light source device 11f in Part (d) of FIG. 8, five semiconductor light-emitting elements 22 are mounted on the assembly holder 16. Each of the semiconductor light-emitting elements 22 is arranged at a position that is five-fold rotational symmetry on the assembly holder 16.

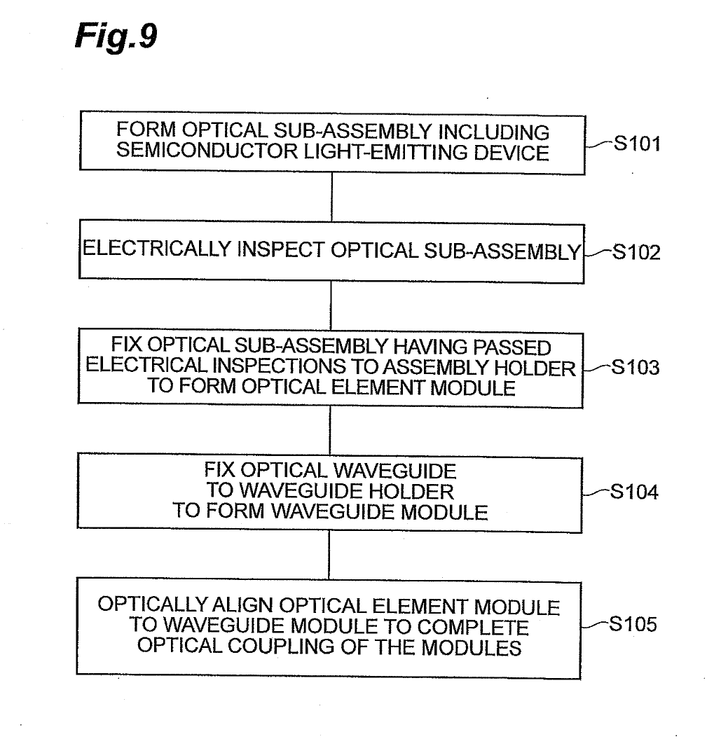

FIG. 9 is a flowchart showing main steps in a method for manufacturing a light source device. In step S101, a sub-assembly 15 illustrated in FIG. 2 is formed. The components for the sub-assembly 15, such as a semiconductor light-emitting element 21, a heat sink 31, and a mount member 33 are prepared. After forming an assembled body by die-bonding the semiconductor light-emitting element 21 with the heat sink 31, the assembled body is mounted on a main surface of the mount member 33. An electrode of the semiconductor light-emitting element 21 and an electrical conductor pattern on the mount member 33 are electrically connected using electrical conductive elements such as bonding wires 47a and 47b. In an example, since the mount member 33 includes a support member 37 and a wiring member 39, the wiring member 39 can be mounted on a main surface of the support member 37 and the lead terminal 35 can be fixed to the wiring member 39. Since the optical sub-assembly 15 is formed in such a manner, the heat dissipation from the semiconductor light-emitting element 21 and the electrical connection of the semiconductor light-emitting element 21 are permitted by the support member 23 and the lead terminal 35. Accordingly, in step S102, an electrical inspection of the optical sub-assembly 15 is performed. For example, the inspection for light emission (intensity and/or wavelength) can be performed by applying voltage to the semiconductor light-emitting element 21. Resulting from this inspection, the assembled body that does not satisfy a predetermined inspection standard is not sent to the next step. Moreover, the assembled body that has satisfied the predetermined inspection standard is sent to the next step as the optical sub-assembly 15.

In step S103, an optical element module is produced by fixing the optical sub-assemblies 15, which have passed the electrical inspection, to an assembly holder 17. The assembly holder 17 illustrated in FIG. 1 is prepared. The hole 17b of the assembly holder 17 extend from a first end to a second end, and the hole 17b is defined by the inner surface 17a. The inner surface 17a has support surfaces for supporting the optical sub-assemblies 15, and each of support surfaces extends in the direction of the axis Ax. Accordingly, the optical sub-assembly 15 can be arranged in the hole 17b by pressing the optical sub-assembly 15 into the hole 17b, after the back surface of the mount member 33 is mounted on the support surface of the inner surface 17a. By repeating this operation, a desired number of optical sub-assemblies 15 can be arranged in the assembly holder 17. Joining of the optical sub-assemblies 15 to the assembly holder 17 can be performed every time when the individual optical sub-assemblies 15 are arranged. Thereby, the optical element module is formed.

In step S104, an optical waveguide module is produced by fixing the optical waveguide 13 to the waveguide holder 41. For production of the light source device 11, since a large number of optical element modules and a large number of optical waveguide modules are previously prepared in general, the order of the step S103 and the step S104 is not important in the manufacturing flow.

In step S105, the light source device 11 is fowled by assembling the optical element module and the optical waveguide module. In the exemplary assembling, the optical element module is optically aligned to the optical waveguide module. This alignment can be performed by, for example, passive alignment. For example, when the optical coupling of the optical waveguide 13 and the optical sub-assemblies 15 can be provided at a desired coupling rate by mechanical assembling of the assembly holder 17 of the optical element module and the waveguide holder 41 of the optical waveguide module such as fitting, the passive alignment can be used. The active alignment can be performed for providing the optical coupling if necessary. The light beams from these light-emitting elements are coupled to the first end face 13a of the optical waveguide 13 of the optical waveguide module by emitting the light beams by applying current to all of the optical sub-assemblies 15 of the optical element module. Subsequently, the intensity of light is measured at the second end face 13b of the optical waveguide 13. The optical element module is aligned to the optical waveguide module so that the intensity of light from the second end face 13b of the optical waveguide 13 exceeds a desired value.

In a specific example, the mounting clearance of the semiconductor light-emitting element 21 onto the mount member 33 is, for example, from about −0.02 mm to about +0.02 mm, and the mounting clearance of the optical sub-assembly 15 onto the assembly holder 17 is, for example, from about −0.02 mm to about +0.02 mm. From these values, there is a positional variation of the light-emitting area from about −0.04 mm to about +0.04 mm at the maximum. It is desirable to determine the core size of the optical waveguide 13 based on the positional variation. The light source device 11 is manufactured by these steps.

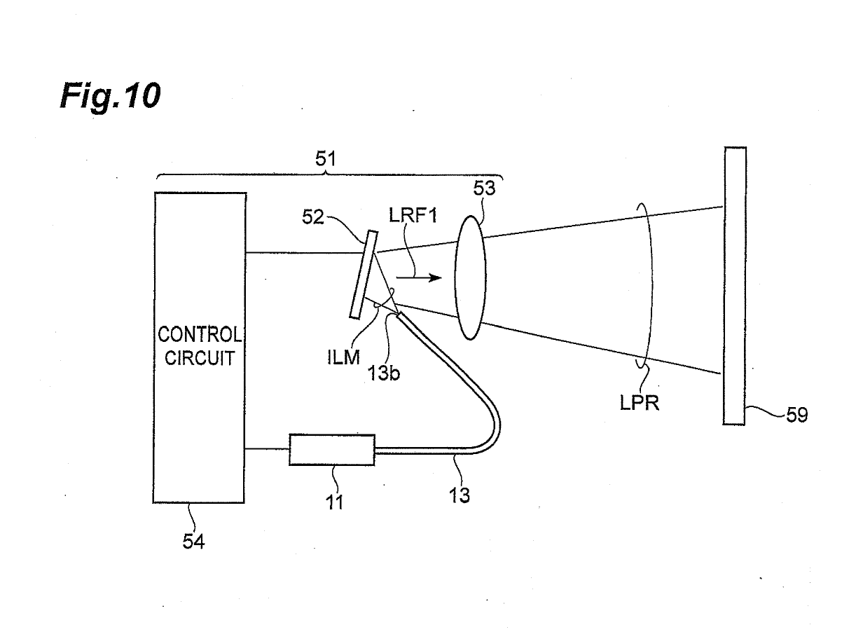

FIG. 10 is an illustration exemplarily showing a display apparatus according to the present embodiment. A display 51 may include various light source devices described in the present embodiment. The display apparatus 51 includes a mirror device 52, a projection lens 53, and a control unit 54. The mirror device 52 receives light beams ILM from the second end face 13d of the optical waveguide 13 of the light source device 11, for example. The mirror device 52 partly or entirely reflects the incident light beams. The mirror device 52 one-dimensionally or two-dimensionally reflects light beams, for example, by a reflection mirror that is rotated by a magnetic force. The mirror device 52 may be an MEMS (micro-electromechanical system). The projection lens 53 generates projection light beams LPR from reflected light beams LRF1 from the mirror device 52, and projects the light beams LPR to a screen 59. The control unit 54 drives the light source device 11 and controls illumination of the light source device 11 (for example, light power and color rendition). In addition, the control unit 54 controls the mirror device 52 (for example, an angle of the mirror and a direction of projection). Because of a low optical loss from the light source to the projection, the display apparatus 51 can reduce power consumption of the light source. Examples of the mirror device 52 in the display apparatus 51 include a digital light processing (DLP) and a liquid crystal on silicone (LCos). The display apparatus 51 operates as described below, for example. The light-emitting elements of the light source device 11 generate red, blue, and green light beams. The light beams having the plurality of wavelengths are combined each other in the optical waveguide 13, thus a white light beam is generated. The white light beam is emitted to the mirror device 52 and the mirror device 52 reflects light of a color corresponding to a video signal from the control unit 54. The reflected light is projected to a screen 59 via the projection lens 53.

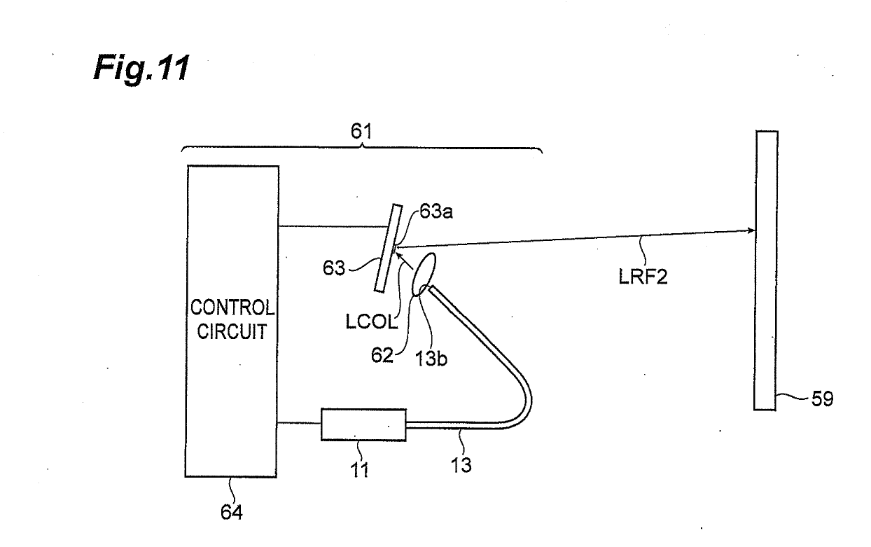

FIG. 11 is an illustration exemplarily showing a display apparatus according to the present embodiment. The display apparatus 61 may include one of the light source devices described in the present embodiment. The display apparatus 61 includes a lens 62, an MEMS device 63, and a control apparatus 64. The lens 62 collimates the light beams form the second end face 13d of the optical waveguide 13 and generates collimated light LCOL. The MEMS device 63 includes a mirror that receives the collimated light LCOL from the lens 62. The mirror generates projection light LRF2 from the collimated light LCOL. The MEMS device 63 may include an array of the MEMS, for example. The control unit 64 drives the light source device 11 and controls illumination of the light source device 11 (for example, the light power and the color rendition). In addition, the control unit 64 controls the mirror angle of the MEMS 63a for scanning of the projection light LRF2 on the screen 59. Because of a low optical loss from the light source to the projection, the display apparatus 61 can reduce power consumption of the light source. The display apparatus 61 operates as described below, for example. The light-emitting elements of the light source device 11 generate red, blue, and green light beams. The light beams having the plurality of wavelengths are combined each other in the optical waveguide 13, thus a white light beam is generated. The white light beam, is converted into a parallel light beam by the lens 62. The MEMS 63a receives the parallel light beam, and scans a reflected light beam (the projection light LRF2) on the screen by the rotation of the mirror.

As described above, the present embodiment provides a light source device having a structure that enables independent inspections of semiconductor light-emitting elements of an optical sub-assembly, while avoiding a thermal interference among a plurality of optical sub-assemblies, and size reduction. The present embodiment also provides a display apparatus including the light source device.

In a light source device according to an aspect of the present embodiment, the assembly holder may have a hole extending from a first end to a second end of the assembly holder in the direction of the predetermined axis, and the plurality of support members may be arranged in the hole of the assembly holder. According to the light source device, the plurality of support members can be arranged in the hole of the assembly holder. Thus, optical coupling can be performed by aligning of the hole of the assembly holder and the optical waveguide. Consequently, the semiconductor light-emitting elements on the support members can be optically coupled to the first end face of the optical waveguide.

In a light source device according to an aspect of the present embodiment, the support member may include a heat sink on which the semiconductor light-emitting element is die-bonded and a mount member having a main surface on which the heat sink is mounted and a back surface supported by the assembly holder. Each of the optical sub-assemblies may further include a lead terminal supported by the mount member. According to the light source device, the support member includes the heat sink and the optical sub-assembly includes the lead terminal. This structure enables heat to dissipate from the semiconductor light-emitting element through the support member and the semiconductor light-emitting element to be electrically connected via the support member.

In the light source device according to an aspect of the present embodiment, the inner surface of the assembly holder may include a plurality of supporting surfaces that respectively supports a plurality of optical sub-assemblies, and a plurality of separating grooves formed between the plurality of supporting surfaces. The light source device can readily dissipate heat from the semiconductor light-emitting elements through the supporting surfaces. Furthermore, the separating grooves can reduce the thermal interference between the optical sub-assemblies on the supporting surfaces.

In the light source device according to an aspect of the present embodiment, the semiconductor light-emitting element may include a substrate and a multilayer semiconductor structure provided on the substrate, and the support member may support the substrate. According to the light source device, since the support member supports the substrate of the semiconductor light-emitting element, the substrate of the semiconductor light-emitting element and the multilayer semiconductor structure are arranged in sequence from the cladding area to the core area of the optical waveguide. Accordingly, the multilayer semiconductor structure including an active layer is disposed closer to the center of the core area than the substrate is. Accordingly, the light-emitting surface of the active layer can be located close to the core area.

In the light source device according to an aspect of the present embodiment, the core may have a substantially circular cross-section, and a light-emitting area in a light-emitting surface of the semiconductor light-emitting element may be arranged along a circle around a point on a predetermined axis. According to the light source device, since the light-emitting areas in the light-emitting surfaces of the semiconductor light-emitting elements are arranged along the circle around the point on the predetermined axis, the light-emitting surfaces of the individual semiconductor light-emitting elements can be optically coupled to the first end face of the core area efficiently.

In the light source device according to an aspect of the present embodiment, the diameter of the circle may be smaller than the diameter of the cross-section of the core area. According to the light source device, the optical coupling efficiency of the light-emitting surface of the individual semiconductor light-emitting element and the first end face of the core area can be enhanced.

The light source device according to an aspect of the present embodiment may further include a waveguide holder for supporting the optical waveguide. The assembly holder may have an alignment surface, and the alignment surface may support an end of the waveguide holder and extend along a reference plane intersecting a predetermined axis. According to the light source device, a plurality of optical sub-assemblies supported by the inner surface of the assembly holder can be aligned to the optical waveguides in the waveguide holder by sliding an end of the waveguide along the alignment surface of the assembly holder.

The light source device according to an aspect of the present embodiment may further include a waveguide holder for supporting the optical waveguide. Each of the assembly holder and the waveguide holder may have a positioning structure for optical alignment between the assembly holder and the waveguide holder. According to the light source device, the positioning structures of the assembly holder and the waveguide holder enable the optical alignment between the plurality of optical sub-assemblies supported by the inner surface of the assembly holder and the optical waveguide supported by the waveguide holder.

In a light source device according to an aspect of the present embodiment, the optical waveguide may include a large-diameter optical fiber. According to the light source device, a sufficient optical coupling efficiency can be provided using a so-called large-diameter optical fiber.

In the light source device according to an aspect of the present embodiment, the optical waveguide may include any one of an optical fiber having a core comprising plastic, an optical fiber having a core comprising quartz glass, an optical fiber having a core comprising polyimide material, a planar waveguide having a core comprising plastic, a planar waveguide having a core comprising quartz glass, a planar waveguide having a core comprising polyimide material, and a photonic crystal. According to the light source device, these optical waveguides can be preferably applied.

Another aspect of the present embodiment is a display apparatus including the above-described light source device. The display apparatus according to another aspect of the present invention includes (a) any one of the above-described light source device; (b) a mirror device receiving light from the second end face of the optical waveguide of the light source device; (c) a lens generating projection light from a reflected light from the mirror device; and (d) a control unit driving the semiconductor light-emitting element of the light source device and controlling the mirror device. Furthermore, the display apparatus according to another aspect of the present invention includes (a) any one of the above-described light source device; (b) a lens collimating light from the second end face of the optical waveguide; (c) an MEMS including a mirror receiving the light from the lens; and (d) a control unit driving the semiconductor light-emitting element of the light source device and scanning light reflected from the MEMS by controlling the MEMS.

As described above, according to an aspect of the present embodiment, the light source device having a structure that enables independent inspections of the semiconductor light-emitting elements of the optical sub-assemblies, while preventing thermal interference among a plurality of optical sub-assemblies. Furthermore, according to another aspect of the present invention, a display apparatus including the light source device is provided.

Although preferred embodiments have been described, while illustrating the principles of the present invention, it should be understood by those skilled in the art that the present invention can be modified in arrangement and detail without departing from these principles. The present invention should not be limited to specific configurations disclosed in the embodiments. Accordingly, we claim all the alterations and modifications from the scope and spirit of the invention.

What is claimed is:

1. A light source device comprising:
a single optical waveguide including a core area extending along a predetermined axis, a cladding area covering a periphery of the core area and extending along the predetermined axis, and a first end face extending along a plane intersecting the predetermined axis;
a plurality of optical sub-assemblies; and
an assembly holder having an inner surface that supports the plurality of optical sub-assemblies, wherein
the plurality of optical sub-assemblies are respectively arranged on a plurality of reference lines and optically coupled to the first end face of the optical waveguide,
each of the optical sub-assemblies includes a semiconductor light-emitting element having a light-emitting surface optically coupled to the first end face of the optical waveguide and a support member on which the semiconductor light-emitting element is mounted,
the support member includes a first electrode and a second electrode, the first electrode is electrically connected to a first electrode of the semiconductor light-emitting element, the second electrode is electrically connected to a second electrode of the semiconductor light-emitting element,
the support members of the optical sub-assemblies are spaced apart from each other in the assembly holder,
the assembly holder directs the light-emitting surface of the semiconductor light-emitting element toward the first end face of the optical waveguide, and
the plurality of reference lines extend in different directions from one point on the predetermined axis of the core area to the cladding area.

2. The light source device according to claim 1, wherein the assembly holder has a hole extending from a first end to a second end of the assembly holder in the direction of the predetermined axis, and the plurality of support members are arranged in the hole of the assembly holder.

3. The light source device according to claim 1, wherein the support member includes:
a heat sink on which the semiconductor light-emitting element is die-bonded; and
a mount member having a main surface on which the heat sink is mounted and a back surface supported by the assembly holder, wherein
each of the optical sub-assemblies further includes a lead terminal supported by the mount member.

4. The light source device according to claim 1, wherein the inner surface of the assembly holder includes a plurality of supporting surfaces respectively supporting a plurality of optical sub-assemblies, and a plurality of separating grooves formed between the plurality of supporting surfaces.

5. The light source device according to claim 1, wherein the semiconductor light-emitting element includes a substrate and a multilayer semiconductor structure on the substrate, and the support member supports the substrate.

6. The light source device according to claim 1, wherein the core area has a circular cross-section, and a light-emitting area in the light-emitting surface of the semiconductor light-emitting element is aligned along a circle around a point on the predetermined axis.

7. The light source device according to claim 6, wherein the diameter of the circle is smaller than the diameter of the cross-section of the core area.

8. The light source device according to claim 1, further comprising a waveguide holder for supporting the optical waveguide, wherein the assembly holder has an alignment surface, and the alignment surface extends along a reference plane intersecting the predetermined axis and supports an end of the waveguide holder.

9. The light source device according to claim 1, further comprising a waveguide holder for supporting the optical waveguide, wherein each of the assembly holder and the waveguide holder includes a positioning structure for optical alignment between the assembly holder and the waveguide holder.

10. The light source device according to claim 1, wherein the optical waveguide includes a large-diameter optical fiber.

11. The light source device according to claim 1, _{w}herein the optical waveguide includes any one of an optical fiber having a core comprising plastic, an optical fiber having a core comprising quartz glass, an optical fiber having a core comprising polyimide material, a planar waveguide having a core comprising plastic, a planar waveguide having a core comprising quartz glass, a planar waveguide having a core comprising polyimide material, and a photonic crystal.

12. A display apparatus comprising:
the light source device according to claim 1;
a mirror device receiving light from the second end face of the optical waveguide of the light source device;
a lens generating projection light from reflected light from the mirror device; and
a control unit driving the semiconductor light-emitting element of the light source device and controlling the mirror device.

13. A display apparatus comprising:
the light source device according to claim 1;
a lens collimating light from the second end face of the optical waveguide;
an MEMS including a mirror receiving the light from the lens; and
a control unit driving the semiconductor light-emitting element of the light source device and scanning light reflected from the MEMS by controlling the MEMS.
